(19) United States
(12) Patent Application Publication
(10) Pub. No.: US 2011/0261800 A1
(43) Pub. Date: Oct. 27, 2011

(54) SYSTEM AND METHOD FOR SUPPORTING NETWORK MOBILITY BASED ON IDENTIFIER-LOCATOR SEPARATION

(75) Inventors: Taewan You, Daejeon (KR); Nakjung Choi, Seoul (KR); Eun-Kyoung Paik, Yongin-si (KR); Chulhyun Park, Seoul (KR); Yanghee Choi, Seoul (KR); Taekyung Kwon, Seoul (KR)

(73) Assignee: KT CORPORATION, Seongnam-city (KR)

(21) Appl. No.: 13/141,894

(22) PCT Filed: Dec. 23, 2009
(86) PCT No.: PCT/KR2009/007731

§ 371 Date: Jun. 23, 2011

(30) Foreign Application Priority Data
Dec. 23, 2008 (KR) 10-2008-0132619

(51) Int. Cl. H04W 8/12

(52) U.S. Cl. 370/338

(57) ABSTRACT

A system and method for supporting network mobility based on identifier-locator separation, provides seamless session services to terminals inside the mobile network by enabling a variety of tunnel routers (home tunnel router, visit tunnel router, etc.) on network to store/manage mobile network mapping information for network mobility. The system for supporting network mobility based on identifier-locator separation includes: a mobile router configured to register mobile network identification information in a home tunnel router, and support communication with the home tunnel router, on behalf of mobile network nodes located in a home network; and a home tunnel router configured to support communication with a correspondent node by using tunnel router mapping information, and support communication with the mobile router by using mobile network mapping information.

TECHNICAL FIELD

Exemplary embodiments of the present invention relate to network mobility based on identifier-locator separation; and, more particularly, to a system and method for supporting network mobility based on identifier-locator separation, which provide seamless session services to terminals inside the mobile network by enabling a variety of tunnel routers (home tunnel router, vis it tunnel router, etc.) on network to store and manage mobile network mapping information for network mobility.

Exemplary embodiments of the present invention relate to operations of a mobile router (MR), a home tunnel router (hTR), and a visit tunnel router (vTR), which provide services to terminals when a network moves in an environment where tunnel routers such as Locator Identifier Separation Protocol (LISP) of the Internet Engineering Task Force (IETF) and a global routing database system exist.

### BACKGROUND ART

The IETF proposed the LISP for solving the Internet extension problem. In order to separate IP address identifier and locator, an end system identifier (EID) which is used in an end system, and routing locator (RLOC) which is aggregated by an Internet service provider (IPS) in a core network and used in routing are defined in the LISP. Mapping between the EID and the RLOC is performed in tunnel routers (TR) , called Ingress Tunnel Router (ITR) and Egress Tunnel Router (ETR). Data is transmitted through map-and-encapsulation between the two tunnel routers.

That is, the LISP is a protocol proposed for solving Internet addressing and routing problems. Using interface blocks (ITR and ETR) of the tunnel routers, the LISP discriminate addresses and identifiers of a transit network (e.g., global Internet) and a user network (access network). The EID is a valid address in the user network, and the RLOC is an IP address used at a real router in the transit network.

The LISP is a network based solution which supports routing table extension and traffic engineering. The LISP has an advantage in that it is easily displayed.

However, the LISP protocol does not consider mobility, particularly, network mobility through a mobile router. Consequently, there is a need for methods which support network mobility when the tunnel routers of the LISP exist.

Meanwhile, the IETF developed Network Mobility (NEMO) Basic Support Protocol (RFC 3963) as a network mobility support protocol using a mobile router and a mobile IP. This protocol transmits data using a bi-directional tunneling between the mobile router (MR) and the home agent (HA).

In the case of the conventional NEMO, as the mobile router (MR) moves, the bi-directional tunneling is performed through direct binding of the mobile router (MR) and the home agent (HA). Thus, overhead occurs between the mobile router (MR) and the home agent (HA).

### DISCLOSURE

### Technical Problem

An embodiment of the present invention is directed to a system and method for supporting network mobility based on identifier-locator separation, which provide seamless session services to terminals inside the mobile network by enabling a variety of tunnel routers (home tunnel router, visit tunnel router, etc.) on network to store/manage mobile network mapping information for network mobility.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### Technical Solution

In accordance with an embodiment of the present invention, a system for supporting network mobility based on identifier-locator separation includes: a mobile router configured to register mobile network identification information in a home tunnel router, and support communication with the home tunnel router, on behalf of mobile network nodes located in a home network; and a home tunnel router configured to support communication with a correspondent node by using tunnel router mapping information, and support communication with the mobile router by using mobile network mapping information.

In accordance with another embodiment of the present invention, a system for supporting networkmobilitybased on identifier-locator separation includes: a mobile router configured to register mobile network identification information in a visit tunnel router and support communication with the visit tunnel router on behalf of mobile network nodes located in a visit network; a visit tunnel router configured to register location information on the mobile router in a home tunnel router, and support communication with the home tunnel router; and a home tunnel router configured to support communication with a correspondent node by using tunnel router mapping information, and support communication with the visit tunnel router by using mobile network mapping information.

In accordance with another embodiment of the present invention, a system for supporting networkmobilitybased on identifier-locator separation includes: a home tunnel router configured to support communication with a correspondent node by using tunnel router mapping information, and support communication with a mobile router by using mobile network mapping information; a mobile router configured to register mobile network identification information in a home tunnel router or a visit tunnel router according to a current moving location on behalf of mobile nodes belonging thereto; and a visit tunnel router configured to register mobile network mapping information on the mobile router, which is located in a visit network, in the home tunnel router, and support communication with the correspondent node through a tunneling with the home tunnel router.

In accordance with another embodiment of the present invention, a tunnel router for supporting network mobility based on identifier-locator separation is configured to register and manage mobile network identification information and mobile router address as mobile network mapping information, based on mobile networks, and support movement of the mobile network by using the mobile network mapping information.

In accordance with another embodiment of the present invention, a method for registering a location of a mobile network node includes registering, by a mobile router located in a home network, mobile network identification information in a home tunnel router on behalf of mobile network nodes; and managing, by the home tunnel router, the mobile network identification information by mapping the mobile network identification information with an address of the mobile router.

In accordance with another embodiment of the present invention, a method for registering a location of a mobile network node includes: registering, by a mobile router located in a visit network due to a network movement, mobile network identification information in a visit tunnel router on behalf of mobile network nodes; transmitting, by the visit tunnel router, an address of the mobile router to a home tunnel router of the mobile router; and registering, by the home tunnel router, the address of the mobile router and an address of the visit tunnel router as mobile network mapping information.

In accordance with another embodiment of the present invention, a method for transmitting data of a mobile network located in a home network includes: when a home tunnel router receives data from a correspondent node through Internet, confirming a corresponding mobile router by using mobile network mapping information and transmitting the data; and transmitting, by the corresponding mobile router, the data to a destination mobile network node.

In accordance with another embodiment of the present invention, a method for transmitting data of a mobile network located in a visit network includes: when a home tunnel router receives data from a correspondent node through Internet, performing a first transmission operation of confirming a corresponding visit tunnel router through mobile network mapping information on destination address, and transmitting the data; performing, by the visit tunnel router, a second transmission operation of confirming a corresponding mobile router through mobile network mapping information managed by the visit tunnel router, and transmitting the data; and performing, by the mobile router, a third transmission operation of transmitting the data to a mobile network node corresponding to a destination.

### Advantageous Effects

Unlike the existing LISP protocol based on tunnel routers (ITR/ETR) where the identifier and the locator are separated from each other in consideration of only the Internet extension, without considering the network mobility through the mobile router, the system and method in accordance with the embodiments of the preset invention can effectivelyprovide seamless services to the terminals inside the mobile network through the registration procedure and the update procedure, together with several new devices for supporting the network mobility (home tunnel router (hTR), visit tunnel router (vTR), mobile routers having different dimensions from the existing mobile routers, etc.)

In addition, the prefix is aggregated and transmitted to the global database system, and each tunnel router stores and manages new mapping information for mobile network managed by the tunnel router, together with the local mapping information. In this way, the effective mapping database can be maintained.

Furthermore, by diversifying the existing three-stage mapping in order for more hierarchical use, the existing Internet problem that the IP address is doubly used as the meaning of the identifier and the locator is solved through the ID-location separation, and the group mobility (network mobility) that a plurality of mobile terminals move together can be supported in the optimal state.

Moreover, the network enterpriser can flexibly manage the network resources through the hierarchical mapping according to circumstances. For example, when the network mobility is applied to a small-scale network, Personal Area Network (PAN), and when the network mobility is applied to a large-scale network, Vehicular Area Network (VAN), different network hierarchies maybe established because the management area of the enterprisers are changed.

### BRIEF DESCRIPTION OF THE DRAWINGS

FIG. 1 illustrates a mobile network location registration method in accordance with an embodiment of the present invention.

FIG. 2 illustrates a data transmission method in accordance with an embodiment of the present invention when a mobile network is located in a home network.

FIG. 3 illustratesalocationregistrationmethodinaccordance with an embodiment of the present invention when the mobile network moves to a visit network.

FIG. 4 illustrates a data transmission method according to an embodiment of the present invention when a mobile network moves to the visit network.

FIG. 5 illustrates a mapping database updating method for path optimization in accordance with an embodiment of the present invention.

FIG. 6 illustrates a hierarchical mapping procedure in accordance with an embodiment of the present invention.

### BEST MODE

In accordance with embodiments of the present invention, in order to support network mobility by extending the function of a tunnel router of an existing LISP (extending ITR and ETR of the tunnel router), when a home tunnel router (hTR), which is a tunnel router located in a home network which a mobile router first registered in, and a mobile router move to a new network, seamless session services can be effectively provided to the terminals inside the mobile network through signaling and mapping database management between a visit tunnel router (vTR), which is a tunnel router located in a visit network, and a mobile router (mrTR) supporting the network mobility while performing the functions of another tunnel router (TR) (hereinafter, simply referred to as a mobile router).

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

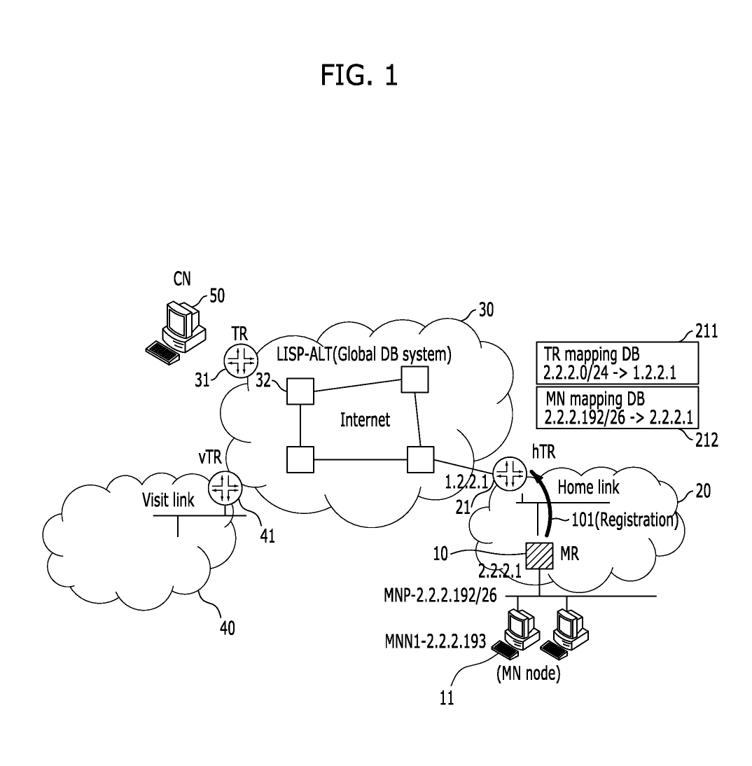

FIG. 1 illustrates a mobile network location registration method in accordance with an embodiment of the present invention.

Referring to FIG. 1, a home tunnel router (hTR) 21, a visit tunnel router (vTR) 41, a correspondent node tunnel router (TR) 31, and a moving router (MR) 10 include specific modules called IRT and ETR. hITR/ETR is associated with the home tunnel router (hTR) 21; vITR/ETR is associated with the visit tunnel router (vTR) 41; mrITR/ETR is associated with the mobile router (MR) 10; and ITR/ETR is associated with the correspondent node tunnel router 31. For conciseness, the home tunnel router (vTR) 41, the correspondent node tunnel router 31, and the mobile router 10 will be used herein.

Unlike the existing LISP, the home TR 21 has two mapping databases 211 and 212. The TR mapping database 211 is a database which stores or registers the user network information which must be pushed through a locator identifier seperation protocol-alternative topology (LISP-ALT) mapping system to the global database (DB) system 30. The MN mapping database 212 is newly added for network mobility. The MN mapping database 212 is a cache-type local database which stores relationship (mapping information) between mobile network prefix (MNP) “2.2.2.192/26” and address “2.2.2.1” of the mobile router (MR) 10.

Furthermore, as illustrated in FIG. 1, the system for supporting network mobility has an LISP-ALT based architecture. Since the LISP-ALT must maintain all binding information in a default tunnel router (more specifically, ITR) where each ISP exists, the tunnel router mapping information is pushed into the Internet 30 on a prefix basis. In this way, the global database information is updated.

The system for supporting network mobility based on identifier-locator separation includes a home tunnel router (hTR) 21, a visit tunnel router (vTR) 41, a correspondent node tunnel router 31, and a mobile router 10. Functions of the respective elements will be described later in detail with reference to FIGS. 1 to 5, but are summarized briefly as follows.

The home tunnel router (hTR) 21 supports communication with the correspondent node 50 by using the tunnel router mapping information, communication with the mobile router (MR) 10 by using the mobile network mapping information, and communication with the visit tunnel router (vTR) 41 by using the mobile network mapping information. The communication between the home tunnel router (hTR) 21 and the mobile router (MR) 10 is achieved through the tunneling.

The visit tunnel router (vTR) 4l registers location information of the mobile router 10 in the home tunnel router (hTR) 21, and supports communication with the home tunnel router (hTR) 21. The visit tunnel router (vTR) 41 communicates with the mobile router 10 or the home tunnel router (hTR) 21 through the tunneling therebetween.

The mobile router 10 registers the corresponding mobile network identification information in the home tunnel router (hTR) 21 on behalf of the mobile network nodes located in the home network, and supports communication with the home tunnel router (hTR) 21. Furthermore, the mobile router 10 registers the corresponding mobile network identification information in the visit tunnel router (vTR) 41 on behalf of the mobile network nodes, and supports communication with the visit tunnel router (vTR) 41.

Hereinafter, an initial registration method of the mobile network prefix (MNP) will be described with reference to FIG. 1.

At step 5101, the mobile network node (MNN) 11 determines its address by using the mobile network prefix (MNP) (i.e., mobile network identification information) received from the mobile router (MR) 10, and registers the corresponding mobile network identification information (e.g., mobile network prefix) in the tunnel router (TR) (i.e. hTR 21) existing in its home network 20 on behalf of the its service terminals (mobile network nodes).

In this case, the home tunnel router (hTR) 21 can know the address “2.2.2.1” of the mobile router 10 as it receives the mobile network prefix. In some embodiments, the mobile router 10 may transmit the mobile network prefix as well as the address of the mobile router 10 to the home tunnel router (hTR) 21. Therefore, the home tunnel router (hTR) 21 stores/manages the relationship between the mobile network prefix and the address of the mobile router 10 as mapping information.

The home tunnel router (hTR) 21 retains the tunnel router (TR) mapping information 211 and the mobile network (MN) mapping information 212.

The mapping relationship (mapping information) between the aggregated address blocks, not the addresses of the mobile network nodes 11, and the address “1.2.2.1” of the corresponding home tunnel router (hTR) 21 which is a real routing path is registered in the tunnel router mapping database 211.

The home tunnel router (hTR) 21 registers only the aggregated mapping information (2.2.2.0/24 ->1.2.2.1 in FIG. 1) in the global database system 32 among the information stored/managed in the tunnel router mapping database 211 and the mobile network mapping database 212.

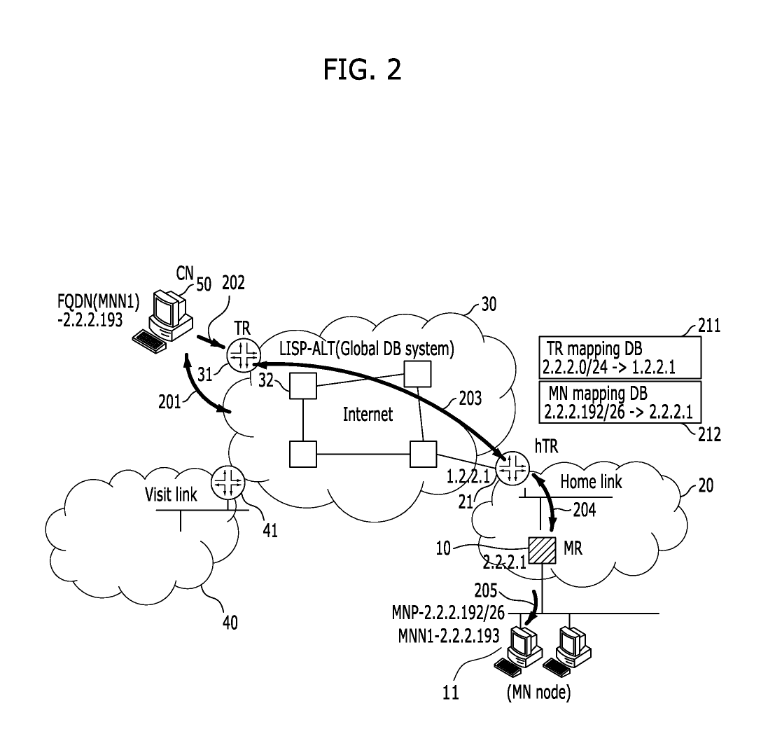

FIG. 2 illustrates a data transmission method in accordance with an embodiment of the present invention when a mobile network is located in a home network.

At step S201, when the mobile network is located in the home network 20 and the correspondent node (CN) 50 intends to communicate with the mobile network node 1 (MNN1) 11, a Fully Qualified Domain Name (FQDN) is searched using a domain name system (DNS), and an Endpoint Identifier (EID) “2.2.2.193” of the mobile network node (MNN) 1 is acquired. The FQDN is a full name of a system and is composed of a host name and a domain name thereof. For example, when “www” is a host name and “terms.co.kr” is a domain name, the FQDN is www.terms.co.kr.

Thereafter, the correspondent node (CN) 50 transmits data through the tunnel router (TR) 31 thereof. The tunnel router (TR) 31 managing the correspondent node (CN) 50 acquires the routing locator (RLOC) corresponding to the EID of the mobile network node 1 (MNN1) 11 lthrough the global database system 32.

At step S202, the global database system 32 applies the longest prefix matching to “2.2.2.193” to acquire information :“2.2.2.0/24 ->1.2.2.1”.

At step S203, the tunnel router (TR) 31 managing the correspondent node (CN) 50 adds a tunnel header to the home tunnel router (hTR) 21 corresponding to “1.2.2.1” and transmits data through the tunneling.

At step S204, the home tunnel router (hTR) 21 receiving the data removes the tunnel header, confirms its local mapping information, and finds the mapping information corresponding to “2.2.2.193”. In this way, it is known that the a destination node is a “mobile network node (MNN) receiving the service through the mobile router 10”, the header directing the mobile router 10 is added, and data is transmitted to the mobile router 10 through the tunneling.

At step 205, the mobile router 10 finally receiving the data removes the header, knows that “2.2.2.193” represents the mobile network node 1 (MNN1) 11 to which the mobile router 10 provides the service, and transmits the data thereto.

In the case of the conventional NEMO, when the mobile router 10 exists in the home network 20, the communication can be provided using the mobile IP, without using the tunneling. However, in accordance with the embodiment of the present invention, since the mobility is supported in a hierarchical structure of a basic ITR(/ETR), without loading the mobile IP, a basic communication method is substantially equal, whether the mobile router 10 exist in the home network 20 or the visit network 40.

Thus, a protocol for the function of the home agent or foreign agent must be loaded on the router equipment corresponding to the tunnel router in order to support the mobile IP, and an extended protocol for NEMO must be additionally loaded. Consequently, much cost and overhead have occurred. However, the embodiment of the present invention solves such problems by using the structure of the standardized router.

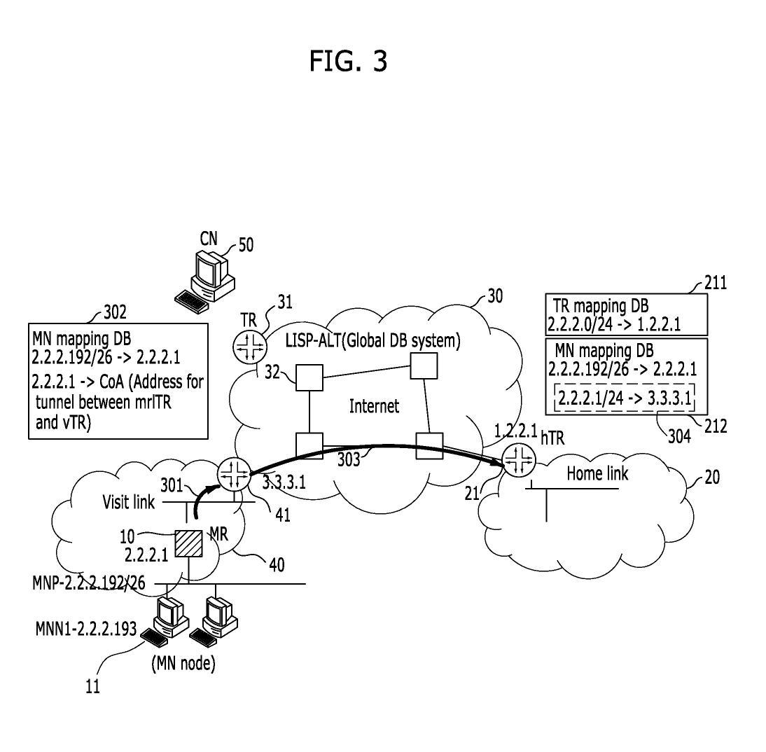

FIG. 3 illustrates a location registration method in accordance with an embodiment of the present invention when the mobile network moves to a visit network.

When the mobile networks (MRs) 10 and 11 move to a visit network 40 where a visit tunnel router (vTR) 41 having a global routable address exists, the mobile router (MR) 10 starts to update for its mobile network nodes (MNNs) 11.

At step S302, in order for the tunneling between the mobile router (MR) 10 and the vis it tunnel router (vTR) 41, the visit tunnel router (vTR) 41 assigns a temporary address (CoA) to the mobile router (MR) 10. In this way, the tunneling is formed between the mobile router (MR) 10 and the visit tunnel router (vTR) 41.

At step S302, the mobile router (MR) 10 registers the information about the corresponding mobile network (e.g., mobile network prefix) in the visit tunnel router (vTR) 41 on behalf of its mobile network nodes (MNNs) 11 . That is, when the mobile router (MR) 10 transmits the mobile network prefix “2.2.2.192/26” to the visit tunnel router (vTR) 41 through the formed tunneling, the visit tunnel router (vTR) 41 stores/manages the relationship between the received mobile network prefix and the mobile router address.

At step S301, in the procedure of registering the information in the visit tunnel router (vTR) 41, the mobile router (MR) 10 checks and sends the predefined field in order not to transmit the mapping information (e.g., the mobile network prefix) to the global database system 32. At step S302, the visit tunnel router (vTR) 41 registers the mapping information in the mobile network mapping database by using the information received from the mobile router (MR) 10.

The visit tunnel router (vTR) 41 acquires the address “1.2.2.1” of the home tunnel router (hTR) 21 from the LISP-ALT by using the mapping information (mobile network prefix) received from the mobile router (MR) 10 having moved to the visit network. At step S303, the visit tunnel router (vTR) 41 forms the bi-directional tunneling for “2.2.2.1/24” in the relationship with the home tunnel router (hTR) 21 corresponding to the acquired address, and the mobile router 10 transmits to the home tunnel router (hTR) 21 the information indicating that the mobile router 10 is located in its network 40.

At step S304, the home tunnel router (hTR) 21 updates its mobile network mapping information. That is, the home tunnel router (hTR) 21 stores the relationship between the address of the mobile router 10 and the address of the visit tunnel router (vTR) 41 as the mapping information (“304” in the block 212).

Meanwhile, unlike the conventional NEMO, when the mobile networks 10 and 11 move, the mobile router (MR) 10 does register the information in the home tunnel router (hTR) 21 not directly but sequentially. That is, when the mobile router (MR) 10 registers its contents (mobile network prefix) in the visit tunnel router (vTR) 41 at step S302, the visit tunnel router (vTR) 41 registers the information (indicating which visit network the mobile network exists in) in the home tunnel router (hTR) 21 at step S304.

In the visit network 40, the tunneling is formed between the mobile router 10 and the visit tunnel router (vTR) 41 through the above-described registration, and the visit tunnel router (vTR) 41 need not additionally push new mapping information to the Internet. Consequently, the LISP-ALT may be effectively operated.

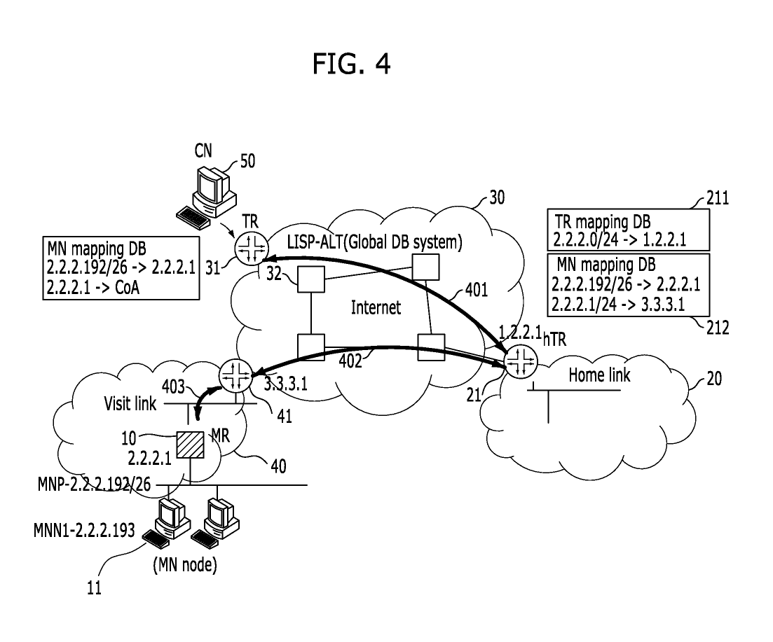

FIG. 4 illustrates a data transmission method according to an embodiment of the present invention when a mobile network moves to the visit network.

At step S401, when the mobile networks (MNs) 10 and 11 move and then the location registration procedure is completed, the correspondent node (CN) 50 transmits data from the tunnel router 31 of the correspondent node 50 to the home tunnel router (hTR) 21 through the tunneling.

At step S402, the home tunnel router (hTR) 21 removes the header from the received data and confirms the mapping information on the destination address “2.2.2.193”. In this case, the home tunnel router (hTR) 21 confirms the mapping information 212 instructing to perform the “3.3.3.1” tunneling on the prefix “2.2.2.0/24”.

At step S403, the visit tunnel router (vTR) 41 removes the header from the received data, confirms the mapping information on “2.2.2.193”, forms the tunneling to “2.2.2.1” (10) registered therein, and transmits data.

The mobile router (MR) 10 having the “2.2.2.1” address transmits the data to the mobile network node 1 (MNN1) 11 to which the mobile router (MR) 10 provides the service.

Due to the standardized/systematic architecture, the communication with the correspondent node (CN) 50 is possible by updating the mobile network mapping information of the visit tunnel router (vTR) 41 and the home tunnel router (hTR) 21 at steps 302 and 304, without additional overhead nor special functions.

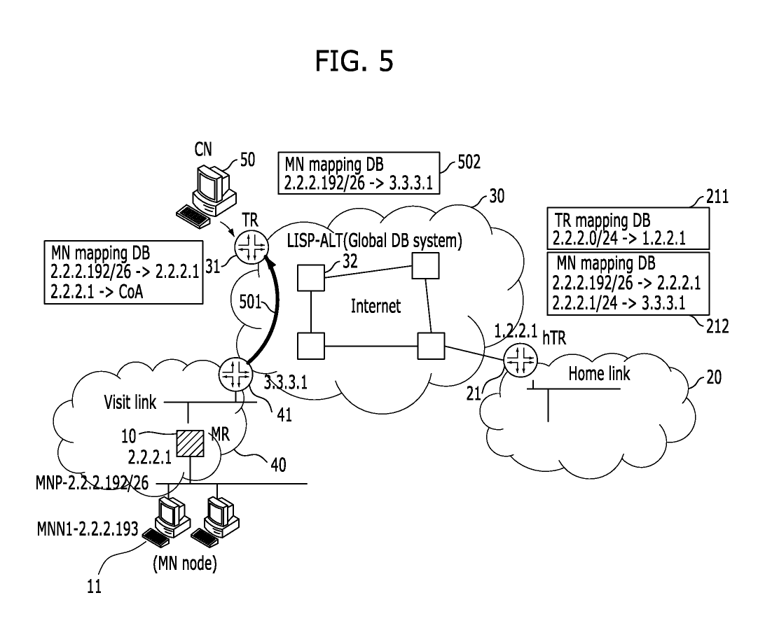

FIG. 5 illustrates a mapping database updating method for path optimization in accordance with an embodiment of the present invention, illustrating the procedure of directly registering the mobile network mapping information in the tunnel router (ITR/ETR) 31 of the correspondent node (CN) 50 at the visit tunnel router (vTR) 41 in order for path optimization up to the correspondent node (CN).

The tunnel routers such as the ITR and the ETR have local caches. Since the visit tunnel router (vTR) 41 continuously receives data from the correspondent node (CN) 50 to the home tunnel router (hTR) 21, the cache is refreshed through a mapping local cache update message for explicit path optimization at step S501. During the cache refresh period, the visit tunnel router (vTR) 41 may directly receive data through the tunneling between the correspondent node tunnel router 31 and the visit tunnel router (vTR) 41.

In the existing NEMO or LISP, the terminal or mobile router (MR) must directly register the mapping information for path optimization. Thus, the security check for valid path or not is performed, which causes the largest overhead in the real handover.

However, when the visit tunnel router (vTR) 41 sends the message that updates only the mapping information, together with the authentication information of the mobile router 10, to the tunnel router 31 where the direct correspondent node (CN) 50 is located at step S501, the optimal path between the tunnel router 31 of the direct correspondent node (CN) 50 and the visit tunnel router (vTR) 41 may be used. Furthermore, this information is stored in the mobile network mapping database provided in the tunnel router 31 of the corresponding node (CN) 50. However, since the information is not updated as the binding information of the Internet 30, the management burden is not given to the LISP-ALT.

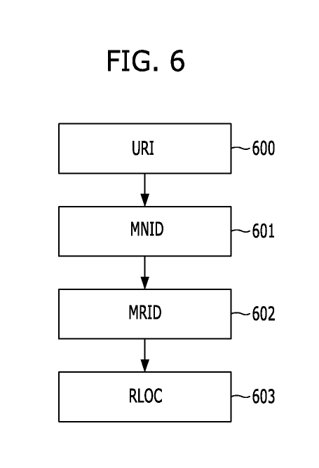

FIG. 6 illustrates a hierarchical mapping procedure in accordance with an embodiment of the present invention. The hierarchical mapping procedure includes the following four stages.

A mapping is performed from a user resource identifier (URI) 600 to a mobile node identifier (MNID) 601 through FQDN such as a DSN. The URI corresponds a domain name, and the MNID is an address of the mobile network node (e.g., “2.2.2.193” in FIG. 1).

The MNID 601 performs the mapping with the identifier of the mobile router (MR) managing the MNID 601, that is, the mapping to the MNID 601 andthemobile router identifier (MRID) 602 is performed. The MRID 602 is the address of the mobile router (e.g., “2.2.2.1” in FIG. 1).

The MRID 602 is converted into the routing locators (RLOC), which is routable in the real network, through the global database system 32 and the home tunnel router (hTR) 21. That is, the mapping of the MRID 602 and the routing locators (RLOC) 603 is performed. The routing locator (RLOC) 603 is an address indicating whether the address is the home network (e.g., “1.2.2.1” or the visit network (e.g., “3.3.3.1”).

The invention can also be embodied as computer programs. Codes and segments constituting the computer programs can be easily construed by programmers skilled in the art to which the invention pertains. Furthermore, the invention is implemented by storing the computer programs in a computer-readable recording medium (information storage medium) and reading and executing them by a computer. The recording medium includes any type of computer-readable recording media.

The present application contains a subject matter related to the Korean Patent Application No. 10-2008-0132619 filed in Korean

Intellectual Property Office on Dec. 23, 2008, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

What is claimed is:

1. A system for supporting network mobility based on identifier-locator separation, the system comprising:
a mobile router configured to register mobile network identification information in a home tunnel router, and support communication with the home tunnel router, on behalf of mobile network nodes located in a home network; and
a home tunnel router configured to support communication with a correspondent node by using tunnel router mapping information, and support communication with the mobile router by using mobile network mapping information.

2. The system of claim 1, wherein communication between the mobile router and the home tunnel router is performed through a tunneling.

3. A system for supporting network mobility based on identifier-locator separation, the system comprising:
a mobile router configured to register mobile network identification information in a visit tunnel router and support communication with the visit tunnel router on behalf of mobile network nodes located in a visit network;
a visit tunnel router configured to register location information on the mobile router in a home tunnel router, and support communication with the home tunnel router; and
a home tunnel router configured to support communication with a correspondent node by using tunnel router mapping information, and support communication with the visit tunnel router by using mobile network mapping information.

4. The system of claim 3, wherein communication between the mobile router and the visit tunnel router is performed through a tunneling.

5. The system of claim 4, wherein communication between the visit tunnel router and the home tunnel router is performed through a tunneling.

6. A system for supporting network mobility based on identifier-locator separation, the system comprising:
a home tunnel router configured to support communication with a correspondent node by using tunnel router mapping information, and support communication with a mobile router by using mobile network mapping information;
a mobile router configured to register mobile network identification information in a home tunnel router or a visit tunnel router according to a current moving location on behalf of mobile nodes belonging thereto; and
a visit tunnel router configured to register mobile network mapping information on the mobile router, which is located in a visit network, in the home tunnel router, and support communication with the correspondent node through a tunneling with the home tunnel router.

7. The system of any one of claims 1, 3 and 6, wherein the mobile network identification information comprises a mobile network prefix.

8. A tunnel router for supporting network mobility based on identifier-locator separation, the tunnel router configured to register and manage mobile network identification information and mobile router address as mobile network mapping information, based on mobile networks, and support movement of the mobile network by using the mobile network mapping information.

9. The tunnel router of claim 8, wherein the tunnel router corresponds to a home tunnel router located in a home network, or a visit tunnel router located in a visit network.

10. The tunnel router of claim 9, wherein, when the tunnel router is the home tunnel router, the tunnel router further performs managing tunnel router mapping information for communication with a correspondent node.

11. The tunnel router of claim 9, wherein the home tunnel router or the visit tunnel router communicates with a mobile router through a tunneling.

12. The tunnel router of claim 9, wherein the visit tunnel router receives mobile network prefix for mobile network nodes from a mobile router, manages the received mobile network prefix, and register an address of the mobile router in a home tunnel router.

13. A method for registering a location of a mobile network node, the method comprising:
registering, by a mobile router located in a home network, mobile network identification information in a home tunnel router on behalf of mobile network nodes; and
managing, by the home tunnel router, the mobile network identification information by mapping the mobile network identification information with an address of the mobile router.

14. The method of claim 13, wherein a tunneling is formed between the mobile router and the home tunnel router.

15. A method for registering a location of a mobile network node, the method comprising:
registering, by a mobile router located in a visit network due to a networkmovement , mobile network identification information in a visit tunnel router on behalf of mobile network nodes;
transmitting, by the visit tunnel router, an address of the mobile router to a home tunnel router of the mobile router; and
registering, by the home tunnel router, the address of the mobile router and an address of the visit tunnel router as mobile network mapping information.

16. The method of claim 15, wherein communication between the mobile router and the visit tunnel router is performed through a tunneling.

17. The method of claim 13 or 15, wherein the mobile network identification information comprises a mobile network prefix.

18. A method for transmitting data of a mobile network located in a home network, the method comprising:
when a home tunnel router receives data from a correspondent node through Internet, confirming a corresponding mobile router by using mobile network mapping information and transmitting the data; and
transmitting, by the corresponding mobile router, the data to a destination mobile network node.

19. The method of claim 18, wherein the home tunnel router transmits the data to the corresponding mobile router through a tunneling.

20. A method for transmitting data of a mobile network located in a visit network, the method comprising:
when a home tunnel router receives data from a correspondent node through Internet, performing a first transmission operation of confirming a corresponding visit tunnel router through mobile network mapping information on destination address, and transmitting the data;
performing, by the visit tunnel router, a second transmission operation of confirming a corresponding mobile router through mobile network mapping information managed by the visit tunnel router, and transmitting the data; and
performing, by the mobile router, a third transmission operation of transmitting the data to a mobile network node corresponding to a destination.

21. The method of claim 18 or20, wherein the first transmission operation comprises:
acquiring, by the correspondent node, an endpoint identifier (EID) of the destination mobile network node by using a domain name system (DNS);
acquiring, by a tunnel router managing the correspondent node, a routing locator (RLOC) corresponding to the identification information through a global data system; and
transmitting, by the tunnel router managing the correspondent node, data received from the correspondent node to the home tunnel router corresponding to the routing locator.

22. The method of claim 20, wherein, in the first transmission operation, the home tunnel router transmits the data to the corresponding visit tunnel router through Internet through a tunneling

23. The method of claim 20, wherein, in the second transmission operation, the visit tunnel router transmits the data to the corresponding mobile router through a tunneling.

24. The method of claim 20, wherein the visit tunnel router forms a tunneling with a tunnel router managing the correspondent node during a cache refresh period through a mapping local cache update message, and receives the data through the tunneling.
